(19) United States
(12) Patent Application Publication
(10) Pub. No.: US 2013/0066659 A1
(43) Pub. Date: Mar. 14, 2013

(54) TRAVEL ARRANGEMENT SERVICE AND METHODS OF DETERMINING ALTERNATIVE ROUTES

(71) Applicant: Stephen C. Denison, Cincinnati, OH (US)

(72) Inventor: Stephen C. Denison, Cincinnati, OH (US)

(21) Appl. No.: 13/593,315

(22) Filed: Aug. 23, 2012

Related U.S. Application Data
(60) Provisional application No. 61/526,496, filed on Aug. 23, 2011.

(51) Int. Cl. G06Q 10/02

(52) U.S. Cl. 705/5

(57) ABSTRACT

A method includes receiving flight information relating to a flight of a travel itinerary, querying a flight data system for alternative flight information and obtaining alternative flight information relating to an alternative flight, creating an alternative flight set from the alternative flight information and processing the alternative flight set to create a prioritized list of alternative travel options. At least a part of the prioritized list is sent to a computing device that is accessible to a passenger or the agent of the passenger, and a selection from the prioritized list is received in return. The travel itinerary of the passenger is modified at least in part based on the selection from the prioritized list.

REFERENCE TO RELATED APPLICATIONS

This application claims priority to U.S. Provisional Patent Application No. 61/526,496, filed Aug. 23, 2011.

### TECHNICAL FIELD

The device, methods, and systems described below relate generally to the field of providing alternative travel arrangements for travelers, and methods of interacting with computing devices to make alternative travel arrangements.

### BRIEF DESCRIPTION OF THE DRAWINGS

FIG. 1 is a system block diagram of a travel arrangement system in an embodiment of the disclosure.

FIG. 2a is a system block diagram of hardware components of a travel arrangement system in an embodiment of the disclosure.

FIG. 2b is a system block diagram of software modules of a travel arrangement system in an embodiment of the disclosure.

FIG. 3 is a state diagram of a set of flight options for purposes of illustrating a travel arrangement method in an embodiment of the disclosure.

FIG. 4 is a flowchart diagram of a travel arrangement system in an embodiment of the disclosure.

FIG. 5 is a flowchart diagram of a flight search in an embodiment of the disclosure.

### DETAILED DESCRIPTION

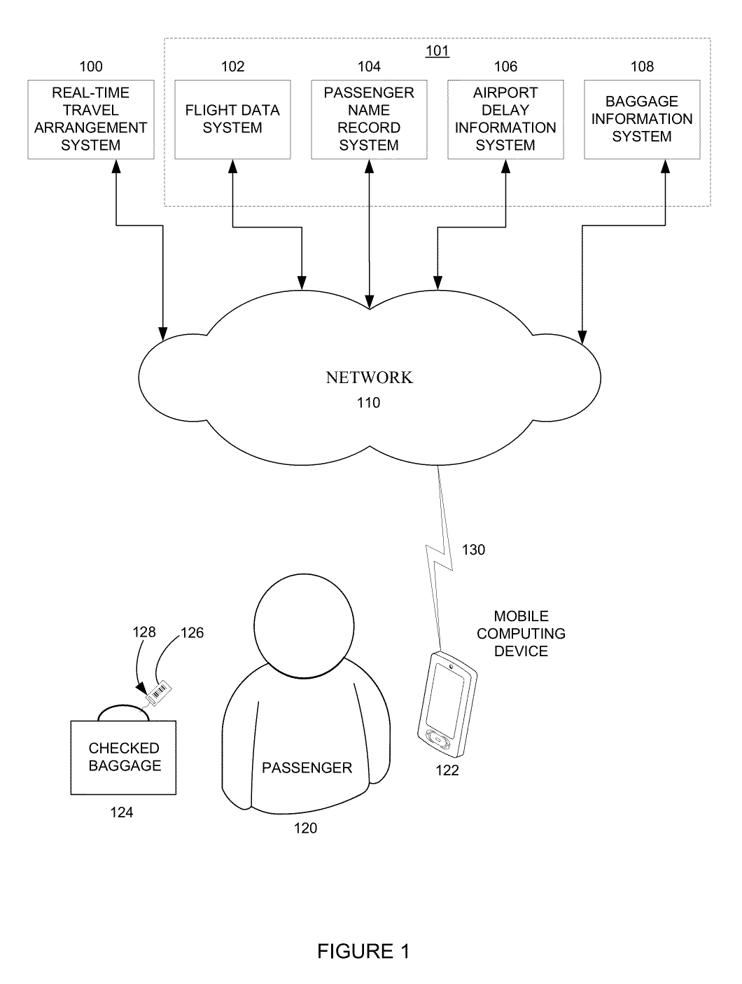

The travel arrangement system 100 of FIG. 1 presents a service for providing alternative travel arrangements that can be accessed by a traveling user, or passenger 120, using a mobile computing device 122. Information about travel delays and interruptions due to weather or equipment malfunctions may first become available to passengers 120 prior to leaving for the airport, when they are on their way to the airport, when they are waiting at an airport, or even when they are seated on an airplane. Passengers 120 may need to change their travel arrangements prior to the travel occurring or after travel has already commenced. Further, many passengers 120 may be unaware of problems with their planned flights until they arrive at the airport or gate and see that their flight is delayed. The passenger 120 therefore loses valuable time when alternative arrangements for travel could have otherwise been sought.

It can be difficult for passengers 120 to make alternative travel arrangements if they booked their flight themselves and did not use travel agent. Passengers 120 may not have access to a computer or network access to book alternative travel arrangements. Passengers 120 may have access to a mobile computing device 122, such as a cell phone, smart phone, tablet or other computing devices as would be understood in the art, and a cellular phone carrier network 130. However mobile computing devices 122 have smaller displays, limited network connectivity, less computing capacity, and less robust input means (e.g., a small keypad versus a full size keyboard and mouse) than desktop or laptop computers. The travel arrangement system 100 provides a means for finding and booking alternative travel arrangements at, or around, the time of the travel interruption using the passenger's 120 mobile computing device 122.

Travel can include air travel (e.g., commercial airline flights), automotive vehicle travel (e.g., bus or car travel), rail travel (e.g., train travel), boat travel (e.g., cruise ship travel), foot travel, and other forms of travel. Travel arrangements can include reservations for travel aboard a commercial carrier such as an airline and reservations for the use of a vehicle, such as a rental car. For clarity of exposition, and for ease of discussion, the travel arrangement system 100 will be described for travel that includes a flight component. However, the disclosure is not intended to be limited to flight-related travel, or travel that originates with or includes a flight component. The examples described below are included for ease of discussion only, and illustrate only a few of the possible configurations of a travel arrangement system 100. The travel arrangement system 100 disclosed herein can be modified from the description below for any kind of travel arrangements, from bus transfers that include foot travel between busses, to any combination of rail, boat, foot or other travel with or without flight travel.

The travel arrangement system 100 can communicate with various other third party systems 101 to obtain information for providing travel arrangements. For example, the travel arrangement system 100 can communicate with flight data information systems 102. Example flight data information system 102 are Amadeus™, Sabre™, Travelport™ (including Worldspan™, Galileo™, and Apollo™), and Flightstats™. A flight data information system 102 provides information regarding available flights and can be a dedicated system for a particular airline carrier, although it is common for multiple carriers to use a common flight data information system 102. The travel arrangement system 100 can communicate with reservation systems, also called passenger name record system (PNR systems 104). Example PNR systems 104 include Computerized Reservation Systems (CRS) and Global Distribution Systems (GDS). Passenger name record systems store the PNRs, or reservations, for passengers 120. The flight data information systems 102 and the PNR systems 104 can be the same system or systems. The travel arrangement system 100 can communicate with one or multiple flight data information systems 102 and PNR systems 104.

The travel arrangement system 100 can also communicate with airport delay information systems 106 and baggage information systems 108. An airport delay information system 106 or baggage information system 108 can be a stand alone system or can be integrated with the flight data information system 102 or PNR system 104. For example, one kind of airport delay information system 106 can be a travel alert system run and operated by a particular airline carrier. Another kind of airport delay information system 106 can be operated by a third party provider, such as an aggregator of flight status information for multiple airlines. Examples of airport delay information systems 106 are Flightstats™, Flightcaster™, and weather information services. The baggage information system 108 can be operated by the airlines, an airport in conjunction with one or more airlines, or by third party service providers to manage checked baggage 124 of passengers 120. In some configurations, baggage information systems 108 monitor both checked baggage 124 and cargo shipments (not shown.) The baggage information system 108 can track the checked baggage 124 of a passenger 120 as it travels within or between airports, as it is loaded or unloaded from an aircraft, or as it is transferred to the baggage claim area of an airport. The checked baggage 124 of a passenger 120 can be tracked using, among other options, barcodes 126 printed on labels secured to the passenger's checked baggage 124 or radio frequency identification RFID tags 128.

The travel arrangement system 100 can communicate with one or more of the third-party systems 101 using, for example, a network 110 such as the Internet. In various configurations, the communications to the third-party systems 101 can include virtual tunnels or secured connections through a network 110, such as the Internet, dedicated communication links through the Public Switched Telephone Network, or PSTN, such as T1, Integrated Services Digital Network (ISDN), or dial-up modem service, wireless communications such as cellular telephone networks 130, or any other kind of networked connection as would be understood by one of ordinary skill in the art.

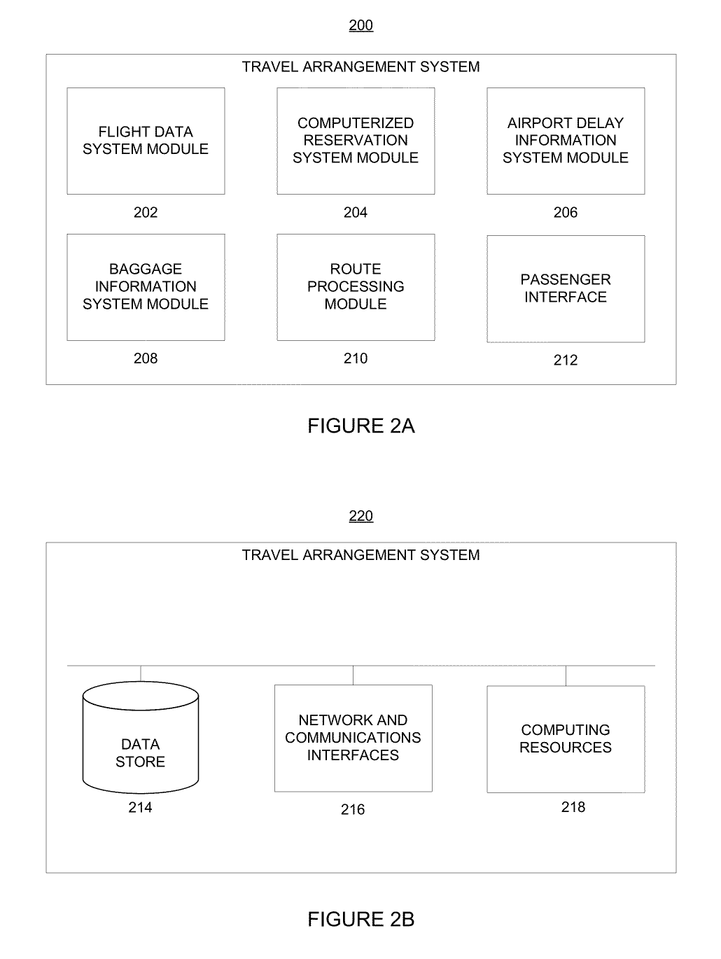

A passenger 120 can communicate with the travel arrangement system 100 using a mobile computing device 122 and a cellular phone carrier's network 130. In one configuration, a passenger 120 can use the mobile computing device 122 to communicate with the travel arrangement system 100 using a web browser on the mobile computing device 122. In another configuration, the mobile computing device 122 can have a dedicated application that runs on the mobile computing device 122 and provides a customized user interface for the passenger 120. In another configuration, the mobile computing device 122 can use email or SMS, or short messaging service, to communicate alerts to the passenger 120. The travel arrangement system 100 can also use email or the SMS texting functions of the mobile computing device 122 to communicate travel options with the passenger 120 and make alternative travel arrangements for the passenger 120, as described in the description for FIG. 2. For example, the travel arrangement system 100 can send an email with a link to the travel arrangement system 100, allowing the passenger 120 to click on the link and access their information on the travel arrangement system 100. Although illustrated using a mobile computing device 122, the travel arrangement system 100 can also be accessed using a web browser on a networked computer (not shown). This allows the passenger 120 or an assistant for the passenger 120 to utilize the travel arrangement system 100 from virtually anywhere. For example, the passenger 120 can access the travel arrangement system 100 from a PC at a hotel, or the assistant for the passenger 120 can take care of the alternative travel arrangements for the passenger 120, for example while the passenger 120 is on a flight.

Referring now to FIG. 2a, the travel arrangement system 200 can include software modules such as a flight data module 202, a reservation system module 204, a flight delay data module 206, a baggage information system module 208, a route processing module 210, and a passenger interface 212. Referring to FIG. 2b, the travel arrangement system 220 can include hardware resources including, but not limited to, a data store 214, computing resources 218, and network and communication interfaces 216. The data store 214, computing resources 218, and network and communication interfaces 216 can be networked together or share a common data bus. The travel arrangement system 200 and travel arrangement system 220 are examples of travel arrangement systems 100, and will collectively be referred to as travel arrangement systems 100.

The data store 214 can be a memory or storage device including, but not limited to random access memory (RAM) such as dynamic RAM (DRAM), static ram (SRAM), flash memory, disk drives, hard drives, redundant array of individual disks or RAID drives, virtual drives, networked drives and other memory means. The computing resources 218 can include physical components, for example processing units such as CPUs, multi-processing units, reduced instruction set computers (RISC), processors that have pipelines, complex instruction set computers (CISC), or digital signal processors (DSP.) The computing resources 218 can also include local computing resources such servers, networked computing resources, and distributed computing devices. Network and communication interfaces 216 can include any suitable physical device and protocol. For example, the network and communication interfaces 216 can include wired data transmission links such as Ethernet and TCP/IP, as well as PSTN communications links such as T1s (or better), ISDN, Digital Subscriber Line (DSL), or dialup modems running a point-to-point protocol or PPP. The network and communication interfaces 216 can include wireless networks and protocols such as cellular networks 130 that use Code Division Multiple Access (CDMA) or Global System for Mobile Communications (GSM). For example, the network and communication interfaces 216 can include an SMS server that communicates SMS texts directly to the mobile computing device 122 of the passenger 120 over a cellular network 130. Alternatively, the network and communication interfaces 216 can forward SMS messages through the network 110 to a cellular network 130 provider who then sends the SMS texts to the mobile computing device 122 of the passenger 120 using the cellular network 130.

In an example, the data store 214 includes passenger profile data about the passenger 120 who is traveling. The data can include details about the passenger's 120 current travel itinerary, including the time of departure, flight information, rental car reservation numbers, arrival time, and hotel reservation. In an example, one component of the passenger profile data is a PNR, or passenger name record, that contains records about the passenger. PNRs can be stored in a database of a Computerized Reservation System (CRS) or a Global Distribution Systems (GDS's). The passenger profile data can also include information about the passenger's preferences, including preferred modes of travel, preferred airline carriers, hotels, and rental car agencies, frequent flyer numbers, award levels within the frequent flyer programs, available windows for travel that can include black-out periods for religious or other reasons, preferred times for departures and arrivals, and preferences relating to direct flights or flights with multiple legs, among other preferences and stored options.

The flight data module 202 can obtain flight data from one or more flight data systems 102, for example by querying the flight data systems 102 about specific flight legs. The structure of the data exchanged between the flight data module 202 and flight data system 102 is governed by one or more application programming interfaces (API). In an example, the flight data module 202 can access flight data that has been previously stored in the data store 214 of the travel arrangement system 100. In an example, the flight data module 202 can receive updates from the flight data system 102 when new flights are added or existing flights are modified. In an example, the flight data system 102 can be Amadeus™, Sabre™, Travelport™ (including Worldspan™, Galileo ™, and Apollo™), or Flightstats™. In an example, the flight data module 202 queries a provider of flight data information, or flight data system 102, when alternative travel routing may be needed by the passenger 120. For example, the flight data module 202 can be queried when certain event triggers occur such as when the passenger's 120 travel itinerary has the passenger 120 booked on a flight that is delayed due to weather delays, crew issues, equipment failures or aircraft maintenance issues, or other issues.

The flight delay data module 206 can monitor flight delay data from an airport delay information system 106 and obtain data regarding flight delays. In an example, the flight delay data module 206 can receive updates from the airport delay information system 106 as flights are delayed, cancelled or otherwise modified from the original scheduled times. In an example, the flight delay data module 206 can receive information from a provider of information regarding airport and flight delays, or airport delay information system 106, such as Flightcaster™ or Flightstats™, or a flight data information system 102 as listed above. In an example, the flight delay data module 206 can periodically query the airport delay information system 106, for example in the hours just prior to the passenger's 120 departure and while the passenger 120 is traveling. In an example, the flight delay data module 206 is configured to receive flight delay messages from the airport delay information system 106 as flight delays occur. For example, the flight delay data module 206 can be set up with the airport delay information system 106 to receive all flight delay messages, in which case the flight delay messages would be checked against the passenger's 120 itinerary to determine if one or more of the passenger's 120 flights has been affected. In an example, the flight delay data module 206 can pass the flight delay messages to the route processing module 210.

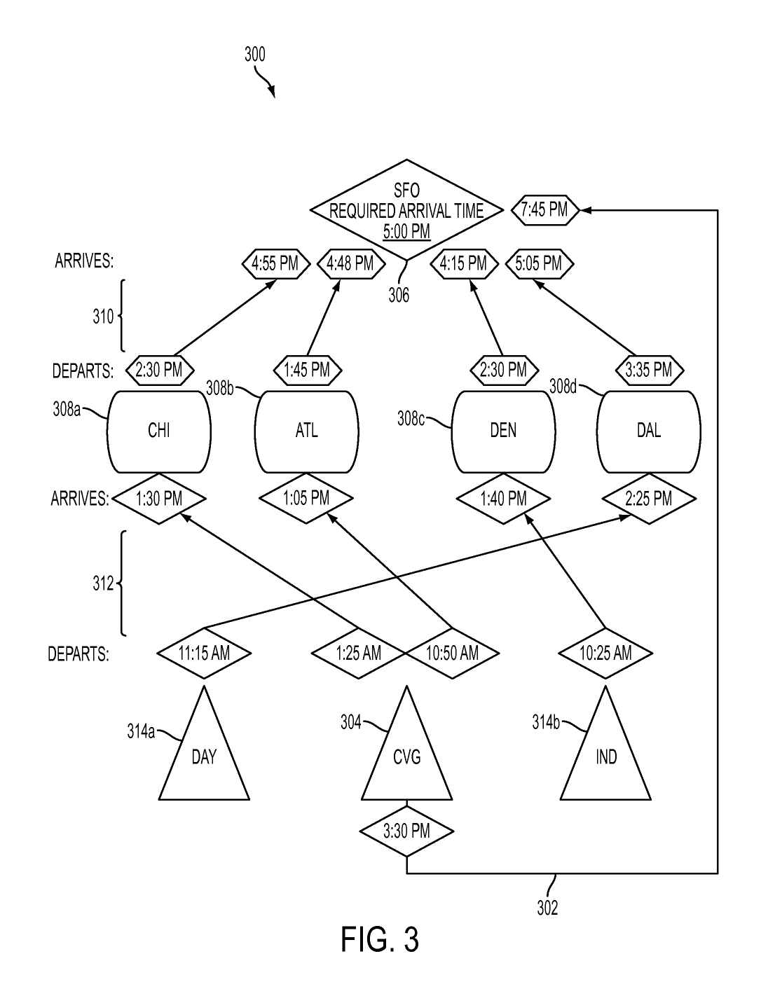

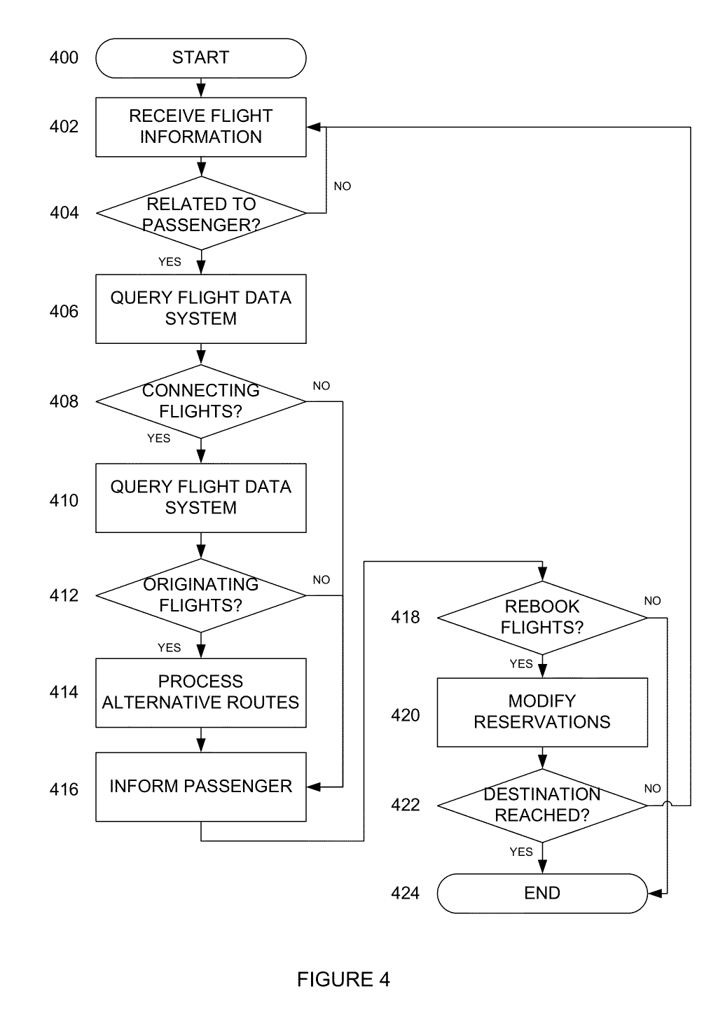

The route processing module 210 can use the flight data information and flight delay data to determine if other travel options that are available for the passenger 120. The route processing module 210 can determine different travel routes and options for the passenger 120 taking into account new information about delays or new flight options as it becomes available. In an example, the route processing module 210 can determine new travel routes when the flight data module 202 or the flight delay data module 206 receives updates. In an example, the route processing module 210 can provide alternative travel options using up-to-date information such as flight delays combined with weather and other data available to the travel arrangement system 100. The route processing module 210 can determine new travel routes taking into account the stored passenger profile data of the passenger 120, as described in additional detail in the description of FIGS. 3 and 4. Once the route processing module 210 has determined new travel routes, the passenger interface 212 can communicate the new travel options to the passenger 120.

The passenger interface 212 can communicate with a client process on the mobile computing device 122 used by a passenger 120, using for example a web browser, a dedicated application on the mobile computing device 122, an email application, or SMS messages sent to the mobile computing device 122 of the passenger 120. The passenger interface 212 can communicate information about the flights of the passenger's 120 itinerary as well as other available travel options. For example, the passenger interface 212 can provide an airline's reservation number where the passenger 120 can discuss rebooking options with one of the airline's customer service agents. The passenger interface 212 can also provide directions to the nearest passenger service counter within the airport for a particular airline. The passenger interface 212 can also provide a coupon code for use with one of the vendors at the airport or nearby to the airport, or other vendors that may make the inconvenience of travel delays more tolerable. In an example, the travel arrangement system 100 can coordinate with the airline that has cancelled or delayed flights to provide passengers 120 with vouchers or coupon codes for use with vendors, hotels, or other services at the airport.

In an example, after receiving new flight options from the passenger interface 212, the passenger 120 can select one of the new travel options using the mobile computing device 122, and the selected travel option is communicated back to the passenger interface 212 through the web browser, the dedicated application on the mobile computing device 122, the email application, or by the passenger 120 sending a confirmation SMS message back to the passenger interface 212. The travel arrangement system 100 can receive the selection from the passenger 120 and modify the passenger's 120 travel reservations or create new travel reservations through the reservation system module 204 and the PNR systems 104. The flight data systems 102 and PNR systems 104 can be the same systems or different systems. The reservation system module 204 can be used to review, add, delete, or modify the travel reservations of a passenger 120 on one or more PNR systems 104. If there is a charge or price difference, the passenger's 120 credit card, debit card, or bank information can be used to pay for the additional charges or a credit can be applied to the passenger's 120 account. The passenger's 120 account information can be stored in the passenger profile data in the data store 214. The passenger interface 212 then sends the passenger 120 a confirmation number for the new reservation. The passenger interface 212 can also send options for printing a boarding pass or include a digital boarding pass that can be displayed on the mobile computing device 122. The travel arrangement system 100 can charge a fee or receive other compensation for performing the described functions.

A baggage information system module 208 can obtain baggage routing information from a baggage information systems 108 and track the checked baggage 124 of a passenger 120. The baggage information system module 208 can query the baggage information system 108 or receive updates from the baggage information systems 108. When the baggage information system module 208 receives new information about the checked baggage 124, the baggage information system module 208 can provide an update to the passenger 120 through the passenger interface 212. Possible updates can include a status update when the checked baggage 124 is loaded onto the aircraft of the passenger 120, a status update when the checked baggage 124 is transferred to a connecting flight, and a status update when the checked baggage 124 is delivered to the destination airport. The baggage information system module 208 can also provide an update if the flight status indicates that the flight for the passenger 120 has departed but that the checked baggage 124 was not reported as being loaded onto the aircraft, as this may provide the passenger 120 with information about their checked baggage 124. For example, the checked baggage 124 may be lost or its arrival at the destination airport may occur at a different time than the passenger 120.

Referring now to FIGS. 3 and 4, a state diagram of a set of flight options 300 and a flow chart diagram of an exemplary operation route processing module 210 for providing travel arrangements are presented. The state diagram of the set of flight options 300 is presented for purposes of illustrating a method of providing travel arrangements and the disclosure is not intended to be limited solely to this configuration.

In an example situation presented in FIG. 3, a passenger 120 at the Cincinnati airport (CVG 304) booked a direct flight 302 to San Francisco (SFO 306.) Because of a delay, the direct flight 302 is currently scheduled to depart at 3:30 PM and arrive at 7:45 PM. The route processing module 210 receives information about the delay through the airport delay information system module 206 and checks the passenger profile data in the data store 214 to determine if the passenger 120 needs to arrive at the destination airport, SFO 306, by a particular time. In this example situation, the passenger 120 needs to be at SFO 306 no later than 5:00 PM. The route processing module 210 starts at the destination airport, SFO 306, and coordinates with the flight data system module 202 to query one or more flight data systems 120 to determine possible flights arriving at SFO 306 prior to 5:00 PM.

In addition to direct flights from the originating airport, CVG 304, the route processing module 210 and flight data system module 202 query for connecting flights 310 arriving from major hub airports 308, for example Chicago, CHI 308a, Atlanta, ATL 308b, Denver, DEN 308c, and Dallas, DAL 308d, collectively hub airports 308. Hub airports 308 generally have more flight options and also may present better future flight options in the event of additional delays or flight cancellations. The route processing module 210 can also search for connecting flights 310 that arrive after the desired arrival time, but may still be viable flight options for the passenger 120. For example the connecting flight 310 that arrives from DAL 308d arrives at SFO 306 at 5:05 PM. Although this connecting flight 310 arrives after the desired arrival time of 5:00 PM, it may still be preferable to the delayed direct flight 302 that arrives at 7:45 PM. The algorithm used by the route processing module 210 can use binary logic, fuzzy logic, weighting algorithms, or other algorithms in combination with the passenger's 120 preferences in determining the best alternative travel routes to present to the passenger 120.

Using the departure times for the connecting flights 310, the flight the route processing module 210 and flight data system module 202 query for originating flights 312 that connect to the hub airports 308 with sufficient time for the passenger 120 to make the connection between the arrival of the originating flight 312 and the departure of the connecting flight 310. The route processing module 210 and flight data system module 202 query for flights that originate not only from the originating airport 304 but also from nearby airports 314, in this example Dayton, DAY 314a, and Indianapolis, IND, 314b, collectively the nearby airports 314. Because many people drive to airports, it can sometimes be advantageous for the passenger 120 to consider driving to a nearby airport 314 in order to get to their destination on time. The nearby airports 314 can be determined using information from the passenger's 120 passenger profile data stored in the data store 214, determined automatically by the travel arrangement system 100, or entered by the passenger 120 in communications with the passenger interface 212.

The route processing module 210 and flight data system module 202 can check flight availability and also check flights against flight delay information received from the airport delay information system module 206 to make sure that the flight options are available to the passenger 120. In an example, the route processing module 210 and flight data system module 202 can query for additional routes having multiple stops, for example having two or more stops at hub airports 308. The route processing module 210 and flight data system module 202 also can query for additional flights that do not use hub airports 308. In an example, the route processing module 210 and flight data system module 202 can continue to query for possible flight options that fall outside of either the desired arrival time or any other criteria in the passenger's 120 passenger profile data stored in the data store 214. In an example, the route processing module 210 can consider alternative means of travel that include bus or rental car travel between airports. For example, it may be possible to arrive earlier by taking a flight to Oakland, OAK (not shown), and then renting a car and driving to the destination, SFO 306.

Once the route processing module 210 has identified potential alternative flights that match criteria in the passenger's 120 passenger profile data stored in the data store 214, the route processing module 210 coordinates with the passenger interface 212 to provide the alternative flight options to the passenger 120. Additional details about the alternative flight options can also be provided to assist the passenger 120 in making decisions. For example, the passenger 120 can be provided the number of available seats on the originating flights 312 and connecting flights 310, the cost differences between the available options, the time between the arrival of the originating flight 312 and the departure of the connecting flight 310 for making the connection, and any other information such as weather forecasts at the various hub airports 308. The passenger 120 can then select an alternative flight option using the passenger interface 212 as described above.

Referring now to FIG. 4, an exemplary flowchart of the operation of the travel arrangement system 100 is presented. Operation starts with start block 400 labeled START. Processing continues to process block 402 where the airport delay information system 206 receives information about a delayed or cancelled flight. Processing continues to decision block 404. In decision block 404, if the information about the delayed or cancelled flight is related to one of the flights of the passenger 120, the processing proceeds to process block 406, otherwise processing returns to processor block 402.

In process block 406, the route processing module 210 and flight data system module 202 query flight data systems 102 for additional flight options for the passenger 120 using options set in the passenger's 120 passenger profile data stored in the data store 214. The route processing module 210 and flight data system module 202 query the flight data systems 102 for flights arriving at the destination, which can be a direct flight 302 from the originating city or connecting flights 310 arriving from hub airports 308. Processing continues to decision block 408.

In decision block 408, if there are no flights that connect to the destination that match the passenger's 120 passenger profile data, then processing continues to process block 416. Otherwise, if there are connecting flights 310, then processing continues to process block 410. In process block 410 the route processing module 210 and flight data system module 202 query flight data systems 102 for originating flights 312 that arrive at the hub airport 308 in time for the passenger 120 to make a connection with the connecting flights 310. Processing continues to decision block 412. In decision block 412, if there are no originating flights that can connect with connecting flights 310 that match the passenger's 120 passenger profile data, then processing continues to process block 416. Otherwise, if there are originating flights 310, then processing continues to process block 414.

In process block 414, the route processing module 210, taking into account the passenger's 120 passenger profile data, determines the best alternative routes for the passenger 120. These routes can be ranked according to any criteria in the passenger's 120 passenger profile data, such as arrival time, travel time, cost, number of flight legs, specific airline carriers, frequent flyer status and the potential for awards such a seat upgrades, seat availability on the aircraft, etc. Processing continues to process block 416.

In process block 416, the passenger 120 is informed about the delayed or cancelled flight, for example by the passenger interface 212 of the travel arrangement system 100 sending one or multiple communications to the passenger's 120 mobile computing device 122. The information can include the airline's reservation number for rebooking. The passenger 120 can also be provided with an option to select alternative travel options from the alternative route determined in process block 414. Processing continues to decision block 418. In decision block 418, if the passenger 120 has selected the option to book one of the alternative travel routes, then that selection is sent by the passenger's 120 mobile computing device 122 back to the passenger interface 212 of the travel arrangement system 100 and processing continues to process block 420, otherwise processing terminates at end block 422 labeled END.

In process block 420, the passenger interface 212 receives the selection of the alternative travel route from the passenger 120. The computerized reservation system module 204 makes the appropriate reservation for the passenger 120 on the passenger name record system 104 and sends a confirmation to the passenger 120, such as the confirmation number for the new reservation and instructions for receiving a new boarding pass. In an example, the confirmation can include a digital boarding pass that can be displayed on the mobile computing device 122. In an example, the passenger interface 212 of travel arrangement system 100 that receives the selection of a new travel route from the passenger 120 can coordinate with the baggage information system 108 to ensure that the passenger's 120 checked baggage 124 is redirected appropriately. Processing continues to decision block 422.

In decision block 422, if the passenger 120 has not reached their destination, then processing then continues back to process block 402 where the travel arrangement system 100 monitors for flight delays or cancellations regarding flights in the passenger's 120 new travel arrangements. Once the passenger 120 reaches their destination, then operation concludes with end block 426 labeled END.

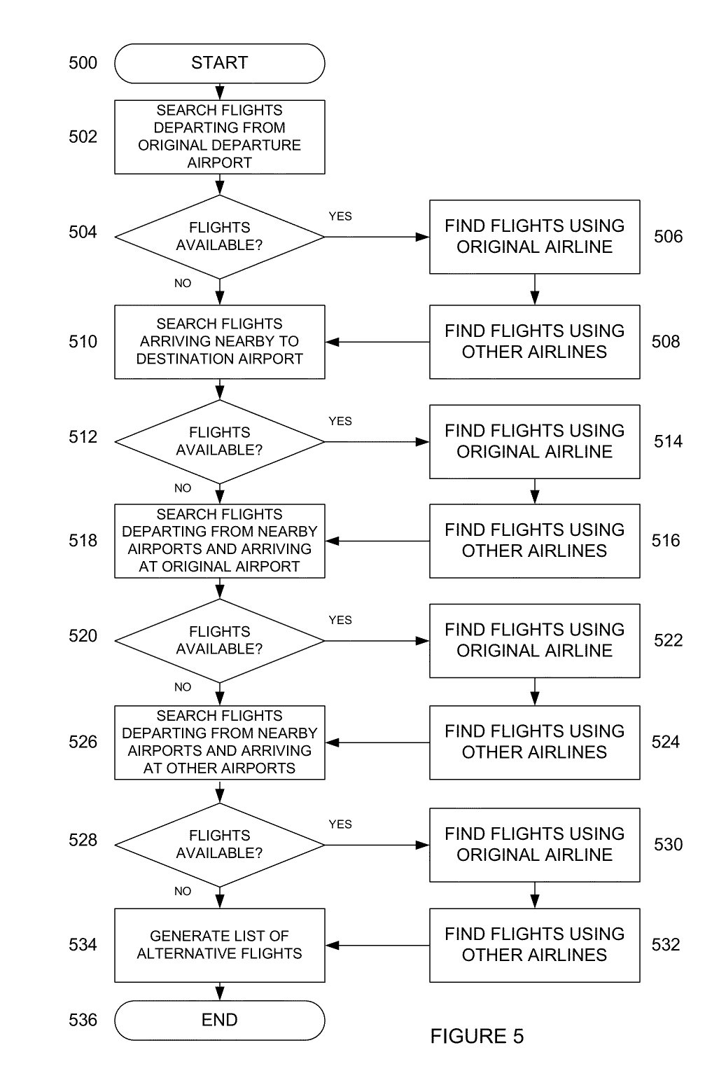

Referring now to FIG. 5, an exemplary flowchart of a flight search is presented. Although the exemplary flowchart is illustrated as operations occurring in a specific order, it should be noted that this is merely one exemplary flowchart. As would be understood by one with familiarity in the art, the operations listed can be performed in any order, can terminate at any point during the list of operations, for example when a suitable alternative flight is found, and the list of operations can include subsets or supersets of these operations. Operation starts with start block 500 labeled START. Processing continues to process block 502 where a search is performed for alternative flights departing from the original departure airport. Flights can be searched based on the criteria as described above for the travel arrangement system of FIG. 4. Processing continues to decision block 504. In decision block 504, if flights are available, processing continues to process block 506, otherwise processing continues to process block 510. In process block 506, the flight search finds those flights that use the original carrier, as these are usually the best candidates for alternative flights that will not incur additional fees. In a later process, the alternative flights can be sorted by airline carrier. Processing continues to process block 508 where the flight search finds flights using other carriers. Processing then continues to process block 510.

In process block 510 a search is performed for alternative flights that arrive at airports nearby to the original arrival airport. Flights can be searched based on the criteria as described above for the travel arrangement system of FIG. 4. Processing continues to decision block 512. In decision block 512, if flights are available, processing continues to process block 514, otherwise processing continues to process block 518. In process block 514, the flight search finds those flights that use the original carrier. Processing continues to process block 516 where the flight search finds flights using other carriers. Processing then continues to process block 518.

In process block 518 a search is performed for alternative flights that arrive at the original destination airport but depart from airports nearby to the original departure airport, for example airports within a short driving distance of the original departure airport. Flights can be searched based on the criteria as described above for the travel arrangement system of FIG. 4. Processing continues to decision block 520. In decision block 520, if flights are available, processing continues to process block 522, otherwise processing continues to process block 526. In process block 522, the flight search finds those flights that use the original carrier. Processing continues to process block 524 where the flight search finds flights using other carriers. Processing then continues to process block 526.

In process block 526 a search is performed for alternative flights that depart from airports nearby to the original departure airport and arrive at airports nearby to the original airport. Flights can be searched based on the criteria as described above for the travel arrangement system of FIG. 4. Processing continues to decision block 528. In decision block 528, if flights are available, processing continues to process block 530, otherwise processing continues to process block 534. In process block 530, the flight search finds those flights that use the original carrier. Processing continues to process block 532 where the flight search finds flights using other carriers. Processing then continues to process block 534.

In process block 534, the list of alternative flights is generated. The list of alternative flights can be used by the travel arrangement system 100, for example to present alternative travel options to passengers 120 as described above. In an example, the list of alternative flights can be sorted and processed to present the top five alternative flights. In another example, the list of alternative flights can be sorted by arrival time, the number of seats available on the flight, additional costs, the number of stops, the airports where the stops occur, or by other parameters. Operation concludes with end block 536 labeled END.

These and other configurations of the travel arrangement system 100 can be used to make, modify, or cancel travel arrangements as would be recognized by those skilled in the art. The above descriptions of various components and methods are intended to illustrate specific examples and describe certain ways of making and using the systems disclosed and described here. These descriptions are neither intended to be nor should be taken as an exhaustive list of the possible ways in which these systems and modules can be made and used. A number of modifications, including substitutions of systems and modules between or among examples and variations among combinations can be made. Those modifications and variations should be apparent to those of ordinary skill in this area after having read this document.

What is claimed is:

1. A method, comprising:
receiving flight information relating to a flight in a travel itinerary;
querying a flight data system for alternative flight information;
obtaining alternative flight information relating to at least one alternative flight as a result of querying the flight data system;
creating an alternative flight set from the alternative flight information;
processing the alternative flight set to create a prioritized list of alternative travel options;
sending at least a part of the prioritized list to a computing device accessible to at least one of a passenger and an agent of the passenger;
receiving a selection from the prioritized list; and
modifying the travel itinerary based at least in part upon the selection.

2. The method of claim 1,
wherein the prioritized list is prioritized based at least in part upon an identity of an airline associated with the alternative flight.

3. The method of claim 2,
wherein a first alternative flight is assigned a priority different from a second alternative flight when an airline of a first alternative flight is also the airline of the flight in a travel itinerary.

4. The method of claim 3,
wherein the travel itinerary includes a departure airport identifier and a destination airport identifier.

5. The method of claim 4,
wherein querying a flight data system includes querying a flight data system for flight alternatives departing from the departure airport associated with the departure airport identifier.

6. The method of claim 5,
wherein querying a flight data system includes querying a flight data system for flight alternatives arriving at the destination airport associated with the destination airport identifier.

7. The method of claim 6,
wherein querying a flight data system includes querying a flight data system for flight alternatives arriving at one or more airports proximate to the destination airport associated with the destination airport identifier.

8. The method of claim 7,
wherein the querying of a flight data system includes querying a flight data system for flight alternatives departing at one or more airports proximate to the departure airport associated with the departure airport identifier.

9. The method of claim 8, wherein modifying the travel itinerary includes at least one of
crediting an account associated with the passenger,
charging an account associated with the passenger,
making a non-flight reservation,
modifying a non-flight reservation,
providing a voucher for use by the passenger, and
providing a coupon code for use by the passenger.

10. The method of claim 9,
wherein the non-flight reservation is a non-flight reservation selected from the group consisting of a rental car reservation, a hotel reservation, a boat reservation, and a bus reservation.

11. The method of claim 10,
wherein the flight information includes at least one of
a notification of a new flight related to the flight;
a notification of a modification of the flight;
a notification of a cancellation of the flight; and
a notification of a delay of the flight.

12. The method of claim 11, further comprising:
querying at least one of
an airport delay information system, and
a weather information system.

13. The method of claim 12, further comprising:
querying a baggage information system for a status of a checked bag of the passenger;
receiving the status of the checked bag; and
sending the status of the checked bag to the computing device.

14. An apparatus, comprising:
a flight data system module configured to receive flight information related to a travel itinerary of a passenger;
an airport delay information system module configured to receive flight delay information;
a data store configured to store at least one of a passenger profile and information associated with the travel itinerary;
a route processing module configured to process flight information and flight delay information and generate a set of alternative travel itineraries that includes at least one alternative travel itinerary;
a passenger interface module configured to
communicate with a mobile communication device of the passenger,
send the set of alternative travel itineraries to the mobile communication device, and
receive a selected alternative travel itinerary; and
a reservation system module configured to
communicate with a passenger record system and
make a reservation based at least in part upon the selected alternative travel itinerary.

15. The apparatus of claim 14,
wherein the reservation system module is further configured to communicate with the mobile communication device and make the reservation while the passenger is travelling.

16. The apparatus of claim 15, further comprising:
a baggage information system module configured to
communicate with a baggage information system,
query a status of a checked bag of the passenger,
receive the status of the checked bag, and
send the status to the mobile computing device.

17. A non-volatile computer-readable medium having computer-executable instructions stored thereon, the computer-executable instructions configured to instruct one or more computer processors to perform the following operations:
receive flight information relating to a flight in a travel itinerary;
query a flight data system for alternative flight information;
obtain alternative flight information relating to at least one alternative flight as a result of querying the flight data system;
create an alternative flight set from the alternative flight information;
process the alternative flight set to create a prioritized list of alternative travel options;
send at least a part of the prioritized list to a computing device accessible to at least one of a passenger and an agent of the passenger;
receive a selection from the prioritized list; and
modify the travel itinerary based at least in part upon the selection.

18. The non-volatile computer-readable medium of claim 17, wherein the computer-executable instructions are further configured to instruct one or more computer processors to
query at least one of
an airport delay information system, and
a weather information system.

19. The non-volatile computer-readable medium of claim 18, wherein the computer-executable instructions are further configured to instruct one or more computer processors to
query a baggage information system for a status of a checked bag of the passenger;
receive the status of the checked bag; and
send the status of the checked bag to the computing device.
